(19) United States
(12) Patent Application Publication
(10) Pub. No.: US 2007/0202032 A1
(43) Pub. Date: Aug. 30, 2007

(54) Process for Producing Caco3 or Mgco3

(75) Inventors: Jacobus Johannes Cornelis Geerlings, Amsterdam (NL); Gerardus Antonius Franciscus Van Mossel, Amsterdam (NL); Bernardus Cornelis Maria In'T Veen, Amsterdam (NL)

Correspondence Address: SHELL OIL COMPANY, P O BOX 2463, HOUSTON, TX, 772522463, US

(73) Assignee: SHELL OIL COMPANY, HOUSTON, TX (US)

(21) Appl. No.: 11/632,668

(22) PCT Filed: Jul. 7, 2005
(86) PCT No.: PCT/EP05/53258

§ 371 Date: Jan. 17, 2007

(30) Foreign Application Priority Data
Jul. 19, 2004 (EP) 04103425.7

(51) Int. Cl. C01B 31/24

(52) U.S. Cl. 423/419.1

(57) ABSTRACT

The present invention relates to a process for producing CaCO3 or MgCO3 from a feedstock comprising a Ca- or Mg-comprising mixed metal oxide, wherein: (a) an aqueous slurry of the feedstock is contacted with a C02 containing gas to form an aqueous solution of Ca(HCO3)2 or Mg(HCO3)2 and a solid Ca- or Mg-depleted feedstock; (b) part or all of the aqueous solution of Ca(HCO3)2 or Mg(HCO3)2 is separated from the solid Ca- or Mg-depleted feedstock; (c) CaCO3 or MgCO3 is precipitated from the separated aqueous solution of Ca(HCO3)2 or Mg(HCO3)2; and (d) the precipitated CaCO3 or MgCO3 is recovered as product. The invention further relates to a process for the production of an aqueous solution of Ca(HCO3)2 or Mg(HCO3)2.

### FIELD OF THE INVENTION

The present invention relates to a process for producing CaCO₃ or MgCO₃ from a feedstock containing a Ca- or Mg-comprising mixed metal oxide and to a process 5 for the production of an aqueous solution of Ca(HCO₃)₂ or Mg(HCO₃)₂.

### BACKGROUND OF THE INVENTION

The rising carbon dioxide concentration in the atmosphere due to the increased use of energy derived from fossil fuels potentially may have a large impact on the global climate. Thus there is an increasing interest in measures to reduce the atmospheric carbon dioxide concentration.

In nature, stable mineral carbonate and silica are formed by a reaction of carbon dioxide with natural silicate minerals. This process of reacting carbon dioxide with mineral substances is also referred to as carbonation or mineralisation and results in free carbon dioxide being bound, i.e. sequestrated. The process follows the reaction:
(Mg,Ca)ₓ Si_{y} O_{x+2y}+x CO₂—>x (Mg,Ca) CO₃+y SiO₂
The reaction in nature, however, proceeds at very low reaction rates.

Recently, the feasibility of such a reaction in industrial plants has been studied. These studies mainly aim at increasing the reaction rate.

At the internet site of the US Department of Energy, http: // www.fetc.doe.gov/publications/factsheets/program/-prog006.pdf, for example, is disclosed the reaction of finely ground serpentine (Mg₃Si₂O₅(OH)₄) or olivine (Mg₂SiO₄) in a solution of supercritical carbon dioxide and water to form magnesium carbonate.

In WO 2002/085788 is disclosed a process for mineral carbonation wherein carbon dioxide is reacted with a bivalent alkaline earth metal silicate, which silicate is immersed in an aqueous electrolyte solution. It is mentioned that the residual compounds obtained after carbonisation, i.e. the mixture of carbonate and silica formed, can be used as filler in construction materials.

Natural minerals suitable for carbonation can be found in abundance and should theoretically provide enough storage facility to sequestrate all the carbon dioxide produced worldwide. When a carbon dioxide sequestration process is located near a mineral production site, the transport cost are low, since the mineral carbonate formed could be stored in used mining pits. However, exploitable mineral resources are generally located far from the place where the carbon dioxide is produced and where it would preferentially be sequestrated. This can lead to high transportation cost for both the reactant and the formed mineral, affecting the industrial applicability of the process.

An alternative for the use of natural minerals as starting material for CO₂ sequestration is the use of mineral rich industrial waste products. These waste materials are generally available close to industrial sites where CO₂-containing off-gases are produced. In ‘Accelerated carbonation of waste calcium silicate materials’ by D. C. Johnson (ISSN 1353-114X) it is disclosed that stainless steel slag, deinking ash, pulverised fuel ash are suitable feedstocks for a carbon dioxide sequestration process.

Also CO₂ sequestation processes using industrial waste materials are economically unattractive, as large volumes of industrial waste are necessary and large volumes of residual materials have to be transported to a storage location.

It is known that residual mineral material from carbonation processes can be treated to extract part of it, thus reducing the total volume to be transported to a storage location.

In U.S. Pat. No. 6,716,408, for example, is disclosed a process for preparing amorphous silica from calcium-silicates. The disclosed process includes the reaction of the calcium-silicate with CO₂ in an aqueous environment with the formation of a suspension of agglomerated particles of SiO₂ and CaCO₃. The suspension is treated with a compound of aluminium, boron, or zinc to form a solution containing SiO₂ particles with nanometric dimensions. Amorphous silica is obtained by separation of the silica solution from the residual solids and subsequent precipitation, drying or gelation. CaCO₃ may be recovered from the solid residue after multiple treatments of the solid residue with sodium aluminate (see EXAMPLE 1B of U.S. Pat. No. 6,716,408). The reaction of silicate with CO₂ is carried out in an autoclave at pressures above ambient pressure. A disadvantage of the process disclosed in U.S. Pat. No. 6,716,408 is that it requires the addition of an aluminium, boron, or zinc compound, i.e. an electrolyte, for the separation of a valuable compound, i.e. silica, from a feedstock comprising a Ca-comprising mixed metal oxide.

In U.S. Pat. No. 5,223,181 is disclosed a process for concentrating radioactive thorium containing magnesium slag by extracting MgCO₃ from it. In the process of U.S. Pat. No. 5,223,181, a slurry of water and magnesium slag is contacted with carbon dioxide, forming a Mg(HCO₃)₂ solution. Subsequently, MgCO₃ is precipitated from the Mg(HCO₃)₂ solution by removal of carbon dioxide. The magnesium slag used in the process of U.S. Pat. No. 5,223,181 contains as main component [4MgCO₃.Mg(OH)₂.4H₂O] and as minor components BaMg(CO₃)₂ and [Mg₆Al₂CO₃(OH)₁₆.4H₂O], i.e. basic magnesium carbonate, a mixed metal carbonate and a basic mixed metal carbonate, respectively. Both basic magnesium carbonate and basic mixed metal carbonate dissolve in water in the presence of carbon dioxide. A disadvantage of the process disclosed in U.S. Pat. No. 5,223,181 is that a relatively low amount of carbon dioxide is sequestrated, e.g. in case of the component [4MgCO₃.Mg(OH)₂.4H₂O] 0.2 moles of carbon dioxide are sequestrated per mole of MgCO₃ produced.

U.S. Pat. No. 6,387,212 discloses a process for removing CaCO₃ from the other insoluble compounds present in various aqueous media, in particular aqueous media from paper for recycling and from deinking sludges. The CaCO₃ is solubilised by contacting the aqueous medium with CO₂, thus forming Ca(HCO₃)₂. The aqueous solution of Ca(HCO₃)₂ is separated from the solid components and mixed with Ca(OH)₂ resulting in the precipitation of CaCO₃ via:
Ca(HCO₃)₂+Ca(OH)₂—>2CaCO₃+2H₂O

The process of U.S. Pat. No. 6,387,212 requires the addition of Ca(OH)₂ for the precipitation of CaCO₃. Ca(OH)₂ is generally obtained by reacting CaO with water. CaO, however, is produced by heating Ca-minerals. Both the combustion of fuel to supply the necessary heat and the conversion from mineral to CaO results in the emission of substantial quantities of CO₂.

### SUMMARY OF THE INVENTION

It has now been found that if mineral feedstocks comprising mixed metal oxides are used for CO₂ sequestration, it is possible to obtain CaCO₃ or MgCO₃ of a high purity, whilst sequestrating a relatively large amount of CO₂. The CaCO₃ or MgCO₃ can be prepared at relatively low temperature and pressure, without the need for additional chemicals. Relatively pure CaCO₃ or MgCO₃ are used in the paper, paint, cosmetic, and pharmaceutical industry, e.g. as filler material and whitening agent.

Accordingly, the present invention relates to a process for producing CaCO₃ or MgCO₃ from a feedstock comprising a Ca- or Mg-comprising mixed metal oxide, wherein:
(a) an aqueous slurry of the feedstock is contacted with a CO₂ containing gas to form an aqueous solution of Ca(HCO₃)₂ or Mg(HCO₃)₂ and a solid Ca- or Mg-depleted feedstock;
(b) part or all of the aqueous solution of Ca(HCO₃)₂ or Mg(HCO₃)₂ is separated from the solid Ca- or Mg-depleted feedstock;
(c) CaCO₃ or MgCO₃ is precipitated from the separated aqueous solution of Ca(HCO₃)₂ or Mg(HCO₃)₂; and
(d) the precipitated CaCO₃ or MgCO₃ is recovered as product.

It is an advantage of the process according to the invention that CO₂ is sequestered and an intrinsically valuable product is obtained. Another advantage is that the process can be performed at relatively low temperature and pressure. A further advantage is that there is no need to add electrolytes or other additional components. Another advantage is that the present process allows an industrial process to effectively sequestrate part of its produced CO₂ in its waste. A still further advantage is that the waste is neutralised and thus made suitable for certain uses, e.g. as foundation or as construction material.

In a further aspect, the invention also relates to the intermediate product of the above-mentioned carbonate production process and therefore to a process for producing an aqueous solution of Ca(HCO₃)₂ or Mg(HCO₃)₂ from a feedstock comprising a Ca- or Mg-comprising mixed metal oxide, the process comprising steps (a) and (b) as hereinbefore defined.

The thus obtained aqueous solution of Ca(HCO₃)₂ or Mg(HCO₃)₂ can be utilized to neutralise (strongly) diluted strong acids or to precipitate organic acids as Ca or Mg compounds.

### BRIEF DESCRIPTION OF THE DRAWING

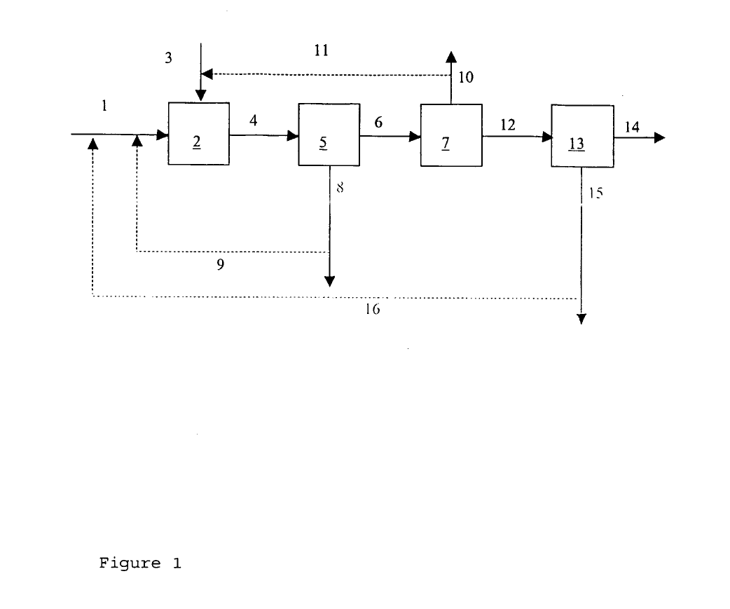

In FIG. 1 a process diagram of an embodiment of the invention is shown.

### DETAILED DESCRIPTION OF THE INVENTION

In the process according to the present invention, intrinsically valuable CaCO₃ or MgCO₃ is prepared whilst carbon dioxide is sequestrated by contacting a feedstock comprising a Ca- or Mg-comprising mixed metal oxide with a CO₂-containing gas.

A mixed metal oxide is herein defined as an oxide containing at least two metals or metalloid components, at least one of them being Ca or Mg. Examples of suitable other metals or metalloids are silicon, iron or a mixture thereof, preferably silicon. The mixed metal oxide may for example be a silicate, a mixed silicate-oxide compound and/or a mixed silicate-oxide-hydroxide compound. The mixed metal oxide may be in its hydrated form.

Any feedstock comprising a Ca- or Mg-comprising mixed metal oxide may be used. The feedstock preferably comprises between 5 and 100 wt % of the Ca- or Mg-comprising mixed metal oxide, based on the total weight of the feedstock, more preferably between 50 and 95 wt %.

Examples of suitable feedstocks are natural occurring Ca- or Mg-minerals, e.g. wollastonite, olivine or serpentine, and industrial waste streams such as steel slag, paper bottom ash, or coal fly ash. Industrial waste streams are preferred feedstocks, since they can generally be obtained at low prices near CO₂ producing facilities. More preferred feedstocks are steel slag and paper bottom ash. Steel slag is obtained during the production of steel. It typically contains, among others, calcium silicates (e.g. Ca₂SiO₄), iron mixed metal oxides (e.g. Ca₂Fe₂O₅) and calcium oxide. Paper bottom ash is obtained as waste material during the recycling of paper and typically contains, among others, calcium silicates (e.g. Ca₂SiO₄), calcium aluminium silicates and calcium oxide. The exact composition of the feedstock can be determined using generally known analysis methods, e.g. XRD. Steel slag is particularly preferred as feedstock.

In the process according to the invention, it is also possible to make mixtures of CaCO₃ and MgCO₃, by using a feedstock comprising both Ca and Mg or by using a mixture of a Ca-comprising feedstock and a Mg-comprising feedstock. The process is preferably a process for producing CaCO₃ from a Ca-comprising mixed metal oxide.

In the process according to the invention, an aqueous slurry of the feedstock is contacted with a CO₂ containing gas. The aqueous slurry suitably contains up to 60 wt % of solid material, based on the total weight of the aqueous slurry, preferably 10 to 50 wt %. The aqueous slurry may, for example, be formed by mixing feedstock particles, preferably particles with an average diameter in the range of from 0.5 μm to 5 cm, with an aqueous stream, preferably water.

Preferably, no electrolytes are added to the aqueous slurry of feedstock.

The CO₂-containing gas that is contacted with the feedstock slurry has preferably a CO₂ partial pressure of at least 0.01 bar, more preferably 0.1 bar, even more preferably 0.5 bar. The CO₂ partial pressure is preferably at most 1 bar, more preferably at most 0.95 bar. Reference herein to CO₂ partial pressure is to the CO₂ partial pressure at Standard Temperature and Pressure (STP) conditions, i.e. at 0° C. and 1 atm. The CO₂ containing gas may be pure CO₂ or a mixture of CO₂ with one or more other gases. Preferably, the CO₂ containing gas is an industrial off-gas, for example an industrial flue gas. An industrial off-gas being defined as any gas released while operating an industrial process.

When the aqueous slurry is contacted with the CO₂-containing gas, CO₂ dissolves in the aqueous phase while forming bicarbonate according to:
CO₂+H₂O<—>H₂CO₃<—>HCO₃⁻+H⁺. (1)
In case the slurry is of an alkaline nature, i.e. the initial pH of the feedstock slurry being higher than that of water, the reaction equilibrium of reaction (1) will be shifted to the right. It is therefore preferred that the pH of the slurry is higher than that of water, more preferably between 6.5 and 14, even more preferably between 7 and 13. Industrial waste streams as steel slag and paper bottom ash are typically alkaline in nature due to the presence of Ca-mixed oxide and often also calcium oxide (CaO) that form calcium hydroxide (Ca(OH)₂) upon contact with water. An advantage of the process according to the invention is that, if such alkaline industrial waste streams are used as feedstock, the resulting Ca- or Mg-depleted feedstock is less alkaline in nature than the original feedstock. The less alkaline depleted feedstock is therefore more suitable to be used in applications where it is in direct contact with the natural environment. In case no alkaline slurry is obtained when mixing the feedstock with water, the pH may be adjusted by methods known in the art to obtain an alkaline slurry.

The bicarbonate formed in reaction (1) reacts with the mixed metal oxide to form calcium or magnesium bicarbonate and Ca- or Mg-depleted feedstock. In the case of calcium silicate as the mixed metal oxide in the solid feedstock, calcium bicarbonate (Ca(HCO₃)₂) and silica (SiO₂) are formed according to reaction (2):
Ca₂SiO₄+4HCO₃⁻+4H⁺—>2Ca(HCO₃)₂+SiO₂+2H₂O (2)

In step (a) of the process according to the invention, the aqueous slurry is contacted with the CO₂ containing gas in a contactor. The contactor can be any appropriate contactor, see for examples Perry's Chemical Engineering Handbook 7^{th} Edition chapter 14, pages 23 to 61 or chapter 23, pages 36 to 39.

Step (a) of the process is preferably carried out at a temperature in the range of from ambient to 200° C., more preferably of from ambient to 150° C., even more preferably of from ambient to 100° C., most preferably of from ambient to 50° C. A relatively low temperature is favourable, since at low temperature the stability of the bicarbonate compounds is high and high concentrations of dissolved Ca- or Mg-bicarbonates are obtained. The pressure at which the aqueous slurry is contacted with the CO₂-containing gas in step (a) is preferably in the range of from 1 to 150 bar (absolute), more preferably of from 1 to 40 bar (absolute), even more preferably of from 1 to 5 bar (absolute).

In step (b) of the process according to the invention, the aqueous solution of calcium or magnesium bicarbonate and the Ca- or Mg-depleted solid feedstock are led to a separator, to separate part or all of the bicarbonate solution from the solid Ca-or Mg-depleted feedstock. Preferably, at least 40% of the bicarbonate solution is separated from the stream comprising the solid feedstock, more preferably 80 to 90 wt % of the bicarbonate solution is separated.

The separator may be any mechanical solid-liquid separator not requiring evaporation of the aqueous medium, preferably a sedimentation or filtration based separator. Such separators are known in the art, see for example Perry's Chemical Engineering Handbook 7^{th} Edition chapter 18, pages 130 to 133. It will be appreciated that the amount of bicarbonate formed is limited by the solubility of the bicarbonate in the aqueous medium and will thus inter alia depend on the ratio of water to solid feedstock. Oversaturation of the bicarbonate solution results in deposition of solid carbonate on the depleted feedstock. This carbonate may be retrieved by recycling the depleted feedstock to step (a) of the process.

In step (c) of the process according to the invention, CaCO₃ or MgCO₃ is precipitated from the separated aqueous solution of Ca(HCO₃)₂ or Mg(HCO₃)₂. Typically, the CaCO₃ or MgCO₃ is precipitated by removing CO₂ from the separated aqueous solution of bicarbonate. This is typically done in a stripper. Strippers are known in the art, for example from Perry's Chemical Engineering Handbook 7^{th} Edition Chapter 14, pages 23 to 61.

The bicarbonate solution is in equilibrium with carbon dioxide according to reaction equation (3):
Mg,Ca(HCO₃)₂<—>Mg,CaCO₃+CO₂+H₂O (3)
It will be appreciated that the equilibrium concentrations are determined by parameters like temperature and CO₂ partial pressure. By removing carbon dioxide, the equilibrium is shifted to the right. Since the solubility of carbonate is much lower than that of bicarbonate, solid Ca- or Mg-carbonate will precipitate upon carbon dioxide removal.

Preferably, the temperature of the aqueous solution of the bicarbonate in the stripper is in the range of from 15 to 95° C., more preferably of from 25 to 85° C., even more preferably of from 50 to 80° C. The CO₂ may be removed by any suitable method. Such methods are known in the art and include release of CO₂ overpressure, stripping with an inert gas (nitrogen or air), or applying a vacuum. A combination of these methods for removing CO₂, simultaneously or sequentially, can be used to increase the carbonate yield. In case of a sequence of CO₂ removal steps, it might be advantageous to decrease the carbonate solubility in each step by lowering the temperature of the aqueous solution of bicarbonate after each step by 5 to 50° C., more preferably by 10 to 20° C., as compared to the previous step. The temperature decrease may for example be achieved by using a cold strip gas or by allowing part of the water to evaporate when applying a vacuum.

Preferably, all or part of the stripped CO₂ is recycled to the contactor, i.e. to step (a) of the process.

Alternatively, the CaCO₃ or MgCO₃ may be precipitated from the separated aqueous solution of Ca(HCO₃)₂ or Mg(HCO₃)2 by ultrasound irradiation of the aqueous solution of the bicarbonate, which can induce the precipitation of the Ca- or Mg-carbonate.

In step (d) of the process according to the invention, the precipitated carbonate is recovered as product. In step (c) an aqueous suspension of carbonate is formed. Solid carbonate may be recovered from this suspension in any suitable way, for example by separating the suspension into substantially pure solid carbonate and an aqueous stream in a separator. The thus-obtained aqueous stream may be (partly) recycled to form the aqueous slurry comprising the feedstock.

If desired, any one of the above-mentioned process steps may be combined or integrated with one or more of the other process steps into a single process step.

Preferably, the Ca- or Mg-carbonate that is recovered as product has an ISO Brightness value of at least 80%, preferably more than 90%, as determined according to ISO 2470. The ISO Brightness value is a measure for the whiteness. It will be appreciated that the whiteness inter alia depends on the purity and the crystal type and size of the carbonate and that the exact process conditions in step (c) of the process, i.e. the step wherein the carbonate is precipitated, will influence the ISO Brightness value. It is within the skills of the skilled person to control process conditions like temperature, bicarbonate concentration, mixing speed, and the optional presence of crystallisation initiators in step (c) in such a way that a carbonate having the desired ISO Brightness value is obtained .CaCO₃ or MgCO₃ produced with the process as hereinbefore defined is particularly suitable to be used in a process for paper manufacture. In such a process the CaCO₃ or MgCO₃ is added to a slurry of cellulose pulp and the CaCO₃ or MgCO₃-comprising pulp is cast and dried in the desired form to obtain a paper product.

### DETAILED DESCRIPTION OF THE DRAWING

The invention is further illustrated by way of example with reference to FIG. 1. In FIG. 1 is schematically shown a flow diagram of a process for producing CaCO₃ from an aqueous slurry of a Ca-mixed metal oxide.

An aqueous slurry of steel slag is fed via conduit 1 to contactor 2. In contactor 2, the aqueous slurry is contacted with a CO₂ containing gas, which is fed to contactor 2 via conduit 3. An aqueous solution of calcium bicarbonate and solid Ca-depleted steel slag are formed in contactor 2. The bicarbonate solution and the depleted steel slag are led together via conduit 4 to separator 5. In separator 5, they are separated into a solids-free stream of bicarbonate solution, which is led via conduit 6 to stripper 7 and a stream comprising the solids, i.e. the depleted steel slag. The stream comprising the solids is discharged from separator 5 via conduit 8. Optionally, part or all of the depleted steel slag is recycled to contactor 2 via conduit 9. In stripper 7, CO₂ is removed from the bicarbonate solution by releasing the overpressure. The CO₂ is discharged from stripper 7 via conduit 10. Alternatively, CO₂ may be removed by supplying strip gas to stripper 7 or by applying vacuum to conduit 10. The stripped CO₂ containing gas may be recycled to contactor 2 via conduit 11. In stripper 7, calcium carbonate precipitates, and thus an aqueous suspension of carbonate is formed. The suspension is subsequently fed via conduit 12 to separator 13. In separator 13, pure solid CaCO₃ is separated from the suspension and recovered as product via conduit 14. An aqueous stream is discharged from separator 13 via conduit 15 and is optionally recycled to contactor 2 via conduit 16.

### EXAMPLES

The invention is further illustrated by way of the following non-limiting examples. All examples are according to the invention.

### Example 1

An aqueous slurry of steel slag was made by mixing 200 g of steel slag with a volume-averaged particle size of 7 μm with 3900 g of water in a 5 L reactor vessel. At ambient conditions, i.e. a temperature of 22° C. and a pressure of 1 bar (absolute), pure CO₂ was bubbled through the slurry during 24 hours. The aqueous phase was then separated from the solids and transferred to a separate vessel. CO₂ was removed from the separated aqueous phase at room temperature by using nitrogen as strip gas. The CaCO₃ precipitate was dried and weighed. The CaCO₃ yield (weight of CaCO₃ per volume of Ca(HCO₃)₂ solution) is reported in the Table.

### Example 2

An aqueous slurry of paper bottom ash slurry was made by mixing 32 g of paper bottom ash with 412 g of water in a 0.5 L reactor vessel. At ambient conditions, i.e. a temperature of 22° C. and a pressure of 1 bar (absolute), pure CO₂ was bubbled through the slurry during 29 hours.

The amount of CO₂ that was absorbed (mainly as CaCO₃) by the paper bottom ash was measured at different points in time by taking a small sample of the paper bottom ash and measuring its weight loss upon heating the sample to 750° C. The CO₂ absorption was calculated as the percent weight loss of the feedstock sample, based on the weight of the sample before heating, and is given in the Table.

After 29 hours, the aqueous phase was separated from the solids and transferred to a separate vessel. CO₂ was removed from the separated aqueous phase at room temperature by using nitrogen as strip gas. The CaCO₃ precipitate was dried and weighed. The CaCO₃ yield (weight of CaCO₃ per volume of Ca(HCO₃)₂ solution) is reported in the Table.

### Example 3

An aqueous slurry of paper bottom ash slurry was made by mixing 50 g of paper bottom ash and 4000 g of water in a 5 L reactor vessel. At ambient conditions, i.e. a temperature of 22° C. and a pressure of 1 bar (absolute), pure CO₂ was bubbled through the slurry during 24 hours. After 24 hours, the aqueous phase was separated from the solids and transferred to a separate vessel. CO₂ was removed from the separated aqueous phase by heating the aqueous phase to a temperature in the range of from 75 to 100° C. The thus-obtained CaCO₃ precipitate was dried and weighed. The CaCO₃ yield (weight CaCO₃ per volume Ca(HCO₃)₂ solution) is reported in the Table.

### Example 4

In different experiments, the amount of carbon dioxide absorbed by steel slag (volume-averaged particle size 7 μm) was measured at different temperatures and pressures. For each experiment, an aqueous slurry of steel slag was made by mixing 64 g of steel slag and 825 g of water in a 1 L reactor vessel and the slurry was contacted with pure CO₂. In the experiments at 10 and 40 bar, the vessel was pressurised with pure carbon dioxide gas. In the experiment at atmospheric pressure (1 bar), carbon dioxide was bubbled through the slurry. The CO₂ absorption was determined as described in EXAMPLE 2. The results are reported in the Table.

### Example 5

In two different experiments, the amount of carbon dioxide absorbed by steel slag (volume-averaged particle size 7 μm) was measured at a CO₂ partial pressure of 3.10⁻⁴ bar and 0.2 bar, respectively. For each experiment, an aqueous slurry of steel slag was made by mixing 64 g of steel slag and 825 g of water in a 1 L reactor vessel and the slurry was contacted with a CO₂-containing gas (air for the experiment at 3.10⁻⁴ bar CO₂ partial pressure) at atmospheric pressure by bubbling the gas through the slurry. The experiments were performed at 22° C. and 28° C., respectively. The CO₂ absorption was determined as described in EXAMPLE 2. The results are reported in the Table.

TABLE
Reaction conditions in step (a) and results of EXAMPLES 1-5

| | | T | p | p(CO₂) | CaCO₃ yield | CO₂ absorption | |
|---|---|---|---|---|---|---|---|
| EXAMPLE | Feedstock | (° C.) | (bara) | (bar) | (wt %) | t | abs. (wt %) |
| 1 | steel slag | 22 | 1 | 1 | 2.6 | | |
| 2 | paper bottom ash | 22 | 1 | 1 | 2.2 | 15′ | 7.3 |
| | | | | | | 60′ | 7.6 |
| | | | | | | 3 h | 8.1 |
| | | | | | | 29 h | 8.6 |
| 3 | paper bottom ash | 22 | 1 | 1 | 1.7 | | |
| 4 | steel slag | 28 | 1 | 1 | | 60′ | 12 |
| | id. | 150 | 10 | 10 | | 15′ | 17.0 |
| | | | | | | 60′ | 19.8 |
| | | | | | | 3 h | 20.4 |
| | | | | | | 6 h | 22.5 |
| | id. | 28 | 40 | 40 | | 30′ | 19 |
| | id. | 150 | 40 | 40 | | 50′ | 16 |
| 5 | steel slag | 22 | 1 | 3 · 10⁻⁴ | | 47 h | 5 |
| | id. | 28 | 1 | 0.2 | | 2 h | 11 |

1. A process for producing CaCO₃ or MgCO₃ from a feedstock comprising a Ca- or Mg-comprising mixed metal oxide, wherein:
(a) an aqueous slurry of the feedstock is contacted with a CO₂ containing gas to form an aqueous solution of Ca(HCO₃)₂ or Mg(HCO₃)₂ and a solid Ca- or Mg-depleted feedstock;
(b) part or all of the aqueous solution of Ca(HCO₃)₂ or Mg(HCO₃)₂ is separated from the solid Ca- or Mg-depleted feedstock;
(c) CaCO₃ or MgCO₃ is precipitated from the separated aqueous solution of Ca(HCO₃)₂ or Mg(HCO₃)₂; and
(d) the precipitated CaCO₃ or MgCO₃ is recovered as product.

2. A process according to claim 1, wherein the CaCO₃ or MgCO₃ is precipitated in step (c) by removing CO₂.

3. A process according to claim 1, wherein the Ca- or Mg-comprising mixed metal oxide comprises silicon or iron.

4. A process for producing CaCO₃ according to claim 1, wherein the feedstock comprises a Ca-comprising mixed metal oxide.

5. A process according to claim 1, wherein the feedstock is an industrial waste product.

6. A process according to claim 1, wherein the aqueous slurry contains up to 60 wt % of solid feedstock based on the total weight of the aqueous slurry.

7. A process according to claim 1, wherein the pH of the aqueous slurry is above that of water.

8. A process according to claim 1, wherein the CO₂ containing gas has a CO₂ partial pressure of at least 0.01 bar, and has a CO₂ partial pressure of at most 1 bar.

9. A process according to claim 1, wherein the slurry of the feedstock contains the feedstock in the form of particles.

10. A process according to claim 1, wherein step (a) is carried out at a temperature in the range of from ambient to 200° C.

11. A process according to claim 1, wherein the operating pressure during step (a) is in the range of from 1 to 150 bar (absolute).

12. A process according to claim 1, any one of the preceding wherein the CO₂ containing gas is an industrial off-gas.

13. A process according to claim 1, wherein the CaCO₃ or MgCO₃ that is recovered as product has an ISO Brightness value of at least 80%.

14. A process for producing an aqueous solution of Ca(HCO₃)₂ or Mg(HCO₃)₂ from a feedstock comprising a Ca- or Mg-comprising mixed metal oxide, the process comprising steps (a) and (b) as defined in claim 1.

15. A process according to claim 2, wherein the Ca- or Mg-comprising mixed metal oxide comprises silicon or iron.

16. A process according to claim 1, wherein the feedstock is steel slag or paper bottom ash.

17. A process according to claim 1, wherein the feedstock is steel slag.

18. A process according to claim 1, wherein the aqueous slurry contains 10 to 50 wt % of solid feedstock based on the total weight of the aqueous slurry.

19. A process according to claim 1, wherein the pH of the aqueous slurry is in the range of from 6.5 to 14.

20. A process according to claim 1, wherein the pH of the aqueous slurry is in the range of from 7 to 13.
